(19) United States
(12) Patent Application Publication
(10) Pub. No.: US 2018/0366770 A1
(43) Pub. Date: Dec. 20, 2018

(54) BIPOLAR LITHIUM-ION BATTERY

(71) Applicant: COMMISSARIAT A L'ENERGIE ATOMIQUE ET AUX ENERGIES ALTERNATIVES, Paris (FR)

(72) Inventors: Sebastien SOLAN, Seyssinet-Pariset (FR); Jeremie SALOMON, Villard De Lans (FR); Djamel MOURZAGH, Sassenage (FR)

(73) Assignee: COMMISSARIAT A L'ENERGIE ATOMIQUE ET AUX ENERGIES ALTERNATIVES, Paris (FR)

(21) Appl. No.: 15/778,054

(22) PCT Filed: Nov. 24, 2016
(86) PCT No.: PCT/EP2016/078665

§ 371 Date: May 22, 2018

(30) Foreign Application Priority Data
Nov. 24, 2015 (FR) 15 61296

(51) Int. Cl. H01M 10/0525; H01M 10/0585; H01M 4/04; H01M 4/66; H01M 4/48; H01M 2/26; H01M 2/24

(52) U.S. Cl. CPC H01M 10/0525; H01M 10/0585; H01M 4/0414; H01M 2004/027; H01M 4/48; H01M 2/26; H01M 2/24; H01M 4/663

(57) ABSTRACT

The invention relates to a bipolar lithium-ion battery comprising n electrochemical cells (C1, C2, C3) connected in series, n being an integer greater than or equal to 2. Each cell comprises a positive electrode (P1, P2, P3), a current collector (2) supporting the positive electrode, a negative electrode (N1, N2, N3), a current collector (8) supporting the negative electrode, and an electrolyte placed between each pair of positive and negative electrodes. In said battery, a so-called “common” current collector (4, 6) from each cell is integral with the current collector from an adjacent cell, the common current collector (4, 6) supporting an electrode of each polarity, and at least the n−1 common current collectors are made of a material formed of carbon fibers.

### TECHNICAL FIELD AND STATE OF PRIOR ART

The present invention relates to a lithium-ion battery.

A lithium-ion battery generally comprises several electrochemical cells connected in series.

Each cell comprises a current collector of the positive electrode, this collector is for example of aluminium, a positive electrode consisting of lithium cation inserting materials. These materials are generally composite materials, for example LiFePO4, or transition metal oxide materials (lamellar materials: LiCoO2: lithiated cobalt oxide, LiNi_{0.33}Mn_{0.33}Co_{0.33}O₂ etc.), a negative electrode, for example of graphite carbon, of metal lithium or in the case of power electrodes of Li₄Ti₅O₁₂, a current collector of the negative electrode. This collector is for example of copper for a graphite carbon electrode or of aluminium in the case of Li₄Ti₅O₁. The positive and negative electrodes are facing each other and an electrolyte is disposed between both of them and in contact with the electrodes. The electrolyte is contained in a microporous polymeric or composite separator, the separator enabling the lithium ion to be moved from the positive electrode to the negative electrode in charging operation, and reversely in discharging operation. The electrolyte is a mixture of organic solvents, most often carbonates in which a lithium salt LiPF6 is added in most cases.

A package or casing is provided around the cell(s).

To fulfil voltage requirements, the cells are connected in series via generally an external electric circuit. Thus, to deliver a 12V voltage, 4 cells with a nominal voltage of 3.2 V or 3.7 V depending on the technologies used are connected in series. The connections are mainly provided by electric cables welded to the terminals of the battery or to connectors (in the case of rigid storage batteries). For flexible type batteries aiming at an application in mobile flexible devices such as screens, E-papers, OPVs, OLED lightings . . . , it is contemplated to print electric tracks on the substrate which makes up the final device for the purpose of integrating the battery therein.

Besides, the collectors conventionally used in industry and in research laboratories in the field of lithium-ion batteries are metallic. Generally, the collectors used are of aluminium for positive electrodes and of titanate Li₄Ti₅O₁₂, of graphite (Cgr), of silicon (Si) or even of silicon carbide (Si—C), of stainless steel, of nickel, of copper, of nickel copper . . . for the negative electrode. In addition, metal collectors have a significant density, lithium-ion batteries thereby decrease in mass energy density. Further the resulting mass of the bipolar battery comprising such collectors can turn out to be detrimental in mobile applications.

It has been proposed to use collectors made of a material of woven or non-woven carbon fibres on which the electrodes are for example made by printing. The material of carbon fibres has a low density, the mass energy density of the cell is thereby little reduced. Further, such collectors are interesting in the case of a mobile application because of their small mass.

Besides, the voltage of the Li-ion battery generally does not exceed 4V, at best 5V. To supply power to devices the operating voltage of which is higher than 4V or 5V, several cells can be connected in series but such connection requires beforehand to make an electric circuit for connecting in series the cells for example by electric wires, printed tracks . . . . The number of operations during assembly is significant.

In order to reduce this number of connections, current collectors can be used which carry on one face a positive electrode and on another face a negative electrode. Such collectors are called bipolar collectors and the battery comprising such collectors is a bipolar battery. Such a battery is for example described in document US2005/0069768. The cells are then stacked on top of each other and connected to each other by the aluminium collectors. The battery has some mass. It cannot be contemplated to use current collectors of carbon fibres as a replacement of aluminium collectors, because the electrodes are generally made by printing and the collector of carbon fibres is porous, thereby there is a risk of ion conduction between both electrodes formed on both faces of the collector.

Further this battery comprising a stack of cells has some bulk and its shape is not necessarily adapted to mobile applications.

### DISCLOSURE OF THE INVENTION

Consequently, a purpose of the present invention is to offer a lithium-ion battery not having the abovementioned drawbacks, in particular to offer a lithium-ion battery able to provide a voltage higher than that of a single cell and adapted to mobile applications.

The purpose set out above is achieved by a lithium-ion battery comprising at least two cells connected in series, each cell comprising a current collector and a negative electrode and a current collector and a positive electrode, at least one current collector of each cell being made as a single piece with a collector of the other cell carrying an electrode of opposite polarity, the collector being of carbon fibres and the electrodes carried by this collector being such that the zones covered with the positive and negative electrodes on the collector are fully distinct from each other.

The collectors can be of woven or non-woven carbon fibres.

By virtue of the invention, it is possible to make batteries offering an increased voltage with respect to that of a single cell, with collectors of carbon fibres. Indeed, the structure of the cell is such that the positive electrode is not made above the negative electrode on an opposite face of the collector to that on which the negative electrode is made, thereby there is no risk of direct contact between the positive and negative electrodes.

Further, the bipolar battery can have a substantially planar configuration adapted to mobile applications. Very interestingly, collectors of carbon fibres have some flexibility, in particular collectors of woven carbon fibres, which enables relatively flexible bipolar batteries to be made which are well adapted to new technologies such as flexible screens, and to mobile applications. Further, the battery can assume different configurations.

Thanks to the implementation of collectors of carbon fibre, the battery has an increased mass energy density and a reduced mass.

In one very advantageous example, the carbon fibres form both the negative electrode and the collector of the negative electrode. The manufacture is simplified and the mass of the battery is further reduced.

The collectors of carbon fibres have some flexibility, they can enable planar and flexible batteries to be made.

Thereby, a subject-matter of the present invention is a lithium-ion bipolar battery comprising n electrochemical cells connected in series, n being an integer higher than or equal to 2, each electrochemical cell comprising a positive electrode, a current collector carrying the positive electrode, a negative electrode, a current collector carrying the negative electrode, an electrolyte disposed between each pair of positive and negative electrodes. A current collector of each cell, called a common current collector, is made as a single piece with the current collector of an adjacent cell, the common current collector carrying an electrode of each polarity, and at least the n−1 common current collectors are of a material made of carbon fibres.

Preferably, all the current collectors are of carbon fibres.

The n−1 common collectors can comprise a negative electrode zone with a surface area at least equal to the surface area of the negative electrode, a positive electrode zone with a surface area at least equal to the surface area of the positive electrode and a connection zone with a reduced surface area with respect to the positive and negative electrode zones between the negative electrode zone and the positive electrode zone.

Preferably, each of the cells is housed in a compartment being tight with respect to that of the other cells.

Very advantageously, the compartments are flexible.

In one exemplary embodiment, the positive electrodes are made of LiFePO₄, LiNi_{0.33}Mn_{0.33}Co_{0.33}O₂, LiNiₓCo_{y}Al_{z}O₂ with x+y+z=1, LiMnO₂, LiNiO₂ or LiNi_{0.4-0.5}Mn_{1.5-1.6}O₄.

The negative electrodes (N1, N2, N3) can be made of titanate (Li₄Ti₅O₁₂), silicon, silicon carbide . . . .

In one advantageous example, the negative electrodes are directly formed by current collector zones facing a positive electrode.

Another subject-matter of the present invention is a method for manufacturing a bipolar battery according to the invention, comprising the steps of

a) providing two unit collectors of electrically conductive material and n−1 common current collectors of carbon fibres,

b) making a negative electrode on a unit current collector (8),

c) making a positive electrode on another unit current collector,

d) making a negative electrode on a zone of the n−1 common current collectors and a positive electrode on another zone of the n−1 common current collectors,

e) facing n−2 positive electrodes carried by n−2 common current collectors with a negative electrode of the n−2 common collectors and facing a remaining positive electrode carried by a common current collector with the negative electrode of a unit current collector and a remaining negative electrode of a common current collector with the positive electrode of the other unit current collector,

f) placing an electrolyte between each facing pair of positive and negative electrodes.

The manufacturing method can comprise the step of making a tight compartment for each cell.

The step of making a tight compartment for each cell can comprise placing the cells in at least one shell and tightly separating the cells and sealing said at least one shell.

Step f) can be made after placing the cells in the shell and before sealing the shell.

Preferably, the heat-sealable tapes are disposed on the common current collectors in the zone between the positive and negative electrodes, the method then comprising a heat application on the heat-sealable tapes.

In one advantageous example, the positive electrodes and/or the negative electrodes are made by printing, for example by screen printing.

### BRIEF DESCRIPTION OF THE DRAWINGS

The present invention will be better understood based on the description that follows and the appended drawings in which:

FIG. 1 is a schematic representation of an exploded view of a battery according to one exemplary embodiment,

FIG. 2 is an outside view of a battery with three cells in series according to one exemplary embodiment,

FIG. 3 is a schematic representation of an exemplary battery according to the invention, its shell being shown in transparency.

### DETAILED DISCLOSURE OF PARTICULAR EMBODIMENTS

In the description that follows, the battery comprises three cells in series, but the battery can comprise at least two cells or more than three cells, the number of cells being chosen as a function of the intended nominal voltage.

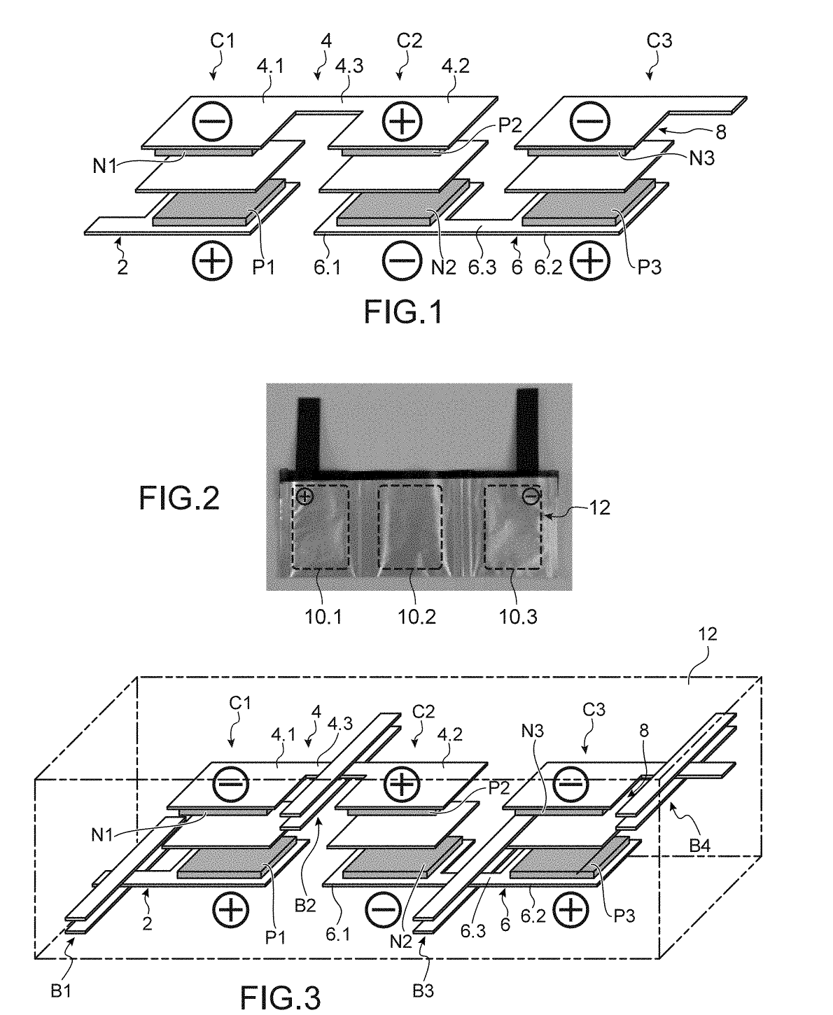

In FIG. 1, an exemplary embodiment of a battery with three cells C1, C2, C3 can be seen. The positive electrodes are symbolised by the sign + and the negative electrodes are designated by the sign −.

In the example represented, the cell C1 comprises a positive electrode P1 in direct contact with a current collector 2, a negative electrode N1 in direct contact with a current collector 4, an electrolyte 6.1 between the positive P1 and negative N1 electrodes.

The cell C2 comprises a positive electrode P2 in direct contact with the current collector 4, a negative electrode N2 in direct contact with a current collector 6, an electrolyte 6.2 between the positive P2 and negative N2 electrodes.

The cell C3 comprises a positive electrode P3 in direct contact with the current collector 6, a negative electrode N3 in direct contact with a current collector 8, an electrolyte 6.3 between the positive P3 and negative N3 electrodes.

The cells C1 and C2 are electrically connected in series by the current collector 4 and the cells C2 and C3 are electrically connected in series by the current collector 6.

The collectors 2 and 4 also form the terminals of the battery, enabling it to be connected either to a user device, or to a charging device.

The cells are separated from each other in a tight manner.

The current collector 4 comprises a first zone 4.1 on which the negative electrode N1 is located, a second zone 4.2 on which the positive electrode P2 is located and a third connection zone 4.3 between the first zone 4.1 and the second zone 4.2.

The current collector 6 comprises a first zone 6.1 on which the negative electrode N2 is located, a second zone 6.2 on which the positive electrode P3 is located and a third connection zone 6.3 between the first zone 6.1 and the second zone 6.2.

Separators S1, S2, S3 are interposed between the positive and negative electrodes P1, N1, P2, N2 and P3, N3 respectively. The separators are porous, more particularly microporous and receive the electrolyte.

In the example represented, the positive electrode and the negative electrode are each made on a zone of the collector, on a same face of the collector. As a variant, it could be contemplated that they are each made on a zone of the collector, i.e. on non-superimposed zones, and on opposite faces of the collector.

In the example represented, the third connection zones 4.3, 6.3 are of a reduced surface area with respect to the zones 4.1, 4.2, 6.1, 6.2 carrying the electrodes. The zones 4.3, 6.3 are in the example represented on an edge of the collector but could be located at any other position between the zones carrying the electrodes. Further, the zones 4.3, 6.3 could extend at an angle between the zones carrying the electrodes. The shape of the collectors and of the electrodes is in no way limiting. The electrodes could for example be disk-shaped or of any other shape. As a variant, the collectors 4 and 6 can be rectangular, the connection extending on the entire width of the collector.

In the example represented, the collectors 4 and 6 substantially extend along an axis and the collectors are disposed the one with respect to the other such that their axes are parallel. As a variant, the collectors could be disposed the one with respect to the other such that their axes are not parallel, for example orthogonal, in this case the battery would extend in a plane. Further as a variant, the collectors 4 and 6 could not extend along an axis but for example the connection zone could have a right angle or any other angle, or even have some curvature.

The collectors 4 and 6 are made as a single piece. They are made from carbon fibres which can be either woven, or non-woven thereby forming a felt.

Preferably, the collectors are of woven carbon fibres when a larger flexibility between the cells is attempted.

For the sake of simplicity, in the following of the description, only carbon fibres will be mentioned.

Advantageously, the collectors 2 and 8 are also made from carbon fibres. But it could be contemplated that they are made of metal.

The cells are each received in a tight compartment 10.1, 10.2, 10.3. In FIG. 2, the cells are received in flexible compartments formed from a single shell 12. As a variant, it could be three distinct shells. Further as a variant, the compartments could be rigid.

The cells also each comprise an electrolyte. This is for example injected in the compartments just before they are sealed.

The positive or negative electrodes could for example be made by printing directly on the collectors of carbon fibre using an ink comprising the active material. Advantageously, it is a screen printing made preferably under suction such that ink penetrates between the carbon fibres. The electrodes obtained offer a very good grip to the collector because of the mechanical anchoring obtained by sucking the ink. Indeed, the electrode material is intermingled between the carbon fibres. Further, the electric conduction between collector and electrode is improved, because an interpenetration appears between the electrode and the percolated network of conductive carbon fibres.

For example, the active material(s) of the positive electrode(s) can be chosen from LiFePO₄, LiNi_{0.33}Mn_{0.33}Co_{0.33}O₂, LiNiₓCo_{y}Al_{z}O₂ with x+y+z=1, LiMnO₂, LiNi_{0.4-0.5}Mn_{1.5-1.6}O₄.

The active material(s) of the negative electrode(s) can be chosen from titanate (Li₄Ti₅O₁₂), silicon, silicon carbide . . . .

In one very advantageous exemplary embodiment, the negative electrode(s) is (are) directly formed by the material of the collector, i.e. the negative electrode(s) is (are) of carbon fibres. Indeed, the inventors have noticed that a material of carbon fibres is able to insert or de-insert Li⁺ cations, thus providing the negative electrode function. It has been measured that an electrode of carbon fibres has substantially the same specific capacity as an electrode of graphite carbon, in the order of 300-310 mAh/g, while having a reduced mass.

The basis weight of the positive electrode(s) and the thickness of the collector of carbon fibres forming the negative electrode are adapted in order to balance the capacity of the positive electrode and the capacity of the negative electrode of carbon fibres.

The active materials for the abovementioned positive electrodes are adapted to an operation with negative electrodes of carbon fibres.

The collectors of carbon fibre have a thickness for example between 50 μm and 300 μm. In the case where the collector also forms the negative electrode, the thickness is preferably between 150 μm and 300 μm. In the case where a positive or negative electrode is formed on the collector, the thickness is preferably lower than 150 μm and advantageously in the order of 50 μm.

The implementation of collectors of carbon fibres enables the mass of each cell and that of the battery to be substantially reduced and thus the mass energy density of the battery to be substantially increased.

By way of comparison, the mass densities of a felt of carbon fibres and other materials usually used to make collectors are given in table I below. It is noticed that the mass density of the felt is dramatically lower than the other metal materials, for example it is four times lower than that of aluminium.

| Material | Mass Density (g/cm³) |
|---|---|
| Aluminium | 2.69 |
| Copper | 8.87 |
| Nickel copper | 8.95 |
| Nickel | 8.90 |
| Stainless steel | 8.62 |
| Felt of carbon fibres (ref. H2315V1)⁽ⁱ⁾ | 0.628 |

⁽ⁱ⁾Freudenberg H2315, PEMFC GDL.

One exemplary method for manufacturing a battery according to one exemplary embodiment of the invention will now be described. The battery comprises in this example negative electrodes directly formed by the collectors.

During a first step, the collectors of carbon fibres are provided, these are for example cut in a felt of carbon fibres with the desired dimensions. Two collectors similar to the collectors 4 and 6 of FIG. 1 and two collectors similar to the collectors 2 and 8 are provided.

During a following step, the positive electrodes are made on a first zone of each collector. The positive electrodes are advantageously made by printing, preferably by screen printing.

By way of example, the ink used to print the positive electrodes can have the following composition:

it comprises LiFePO₄ Pulead® forming the active material, spherical graphite carbon such as Super P (or SP) forming the electron conductor, Vgcf type graphite carbon fibres, a PAAc (poly(acrylic acid)) type polymeric binder, with a molecular mass 1 250 000 g·mol⁻¹.

Preferably, a suction is made through the collector upon printing to increase impregnation of the fibres by the ink.

Three positive electrodes are thus made on three collectors, the last collector forming the collector 8 and the negative electrode 3 is used without modification.

During a following step, the collectors provided with the positive electrodes and the collector forming only the negative electrode are assembled as in FIG. 1. Thus, each positive electrode is facing a zone of the collector of carbon fibres. Three porous separators are then placed between the electrodes. The separators are for example Celgard 2400° membranes.

The assembly thus formed is disposed in a single shell 12. This is advantageously heat-sealable. The shell is for example made from a flexible composite material. The composite material is multilayered and comprises a stack of aluminium layers covered with a polymer. Preferably, the polymeric material is chosen from polyethylene, propylene, and polyamide. An adhesive layer is provided between the aluminium and the polymeric layer, for example it comprises polyester-polyurethane. The shell is for example a composite shell manufactured by Showa-Denko®. The collectors 2 and 8 are dimensioned to project from the package and enable the battery to be electrically connected outwardly.

During a following step, the cells are tightly separated by heat sealing tapes, for example of thermofusible polymer for example of polyethylene, polypropylene located between two cells. The use of polyethylene for separating the cells and more generally the use of heat sealing tapes enable the pores of the collectors of carbon fibres to be filled and the tightness between the cells to be efficiently ensured without degrading the electrical conductivity, by simple melting, for example by applying a temperature in the order of 180° C. for polyethylene.

In FIG. 3, the sealing tapes B1, B2, B3 and B4 can be seen.

The tapes B1 and B4 disposed at the ends of the battery ensure tightness of the cells C1 and C2 relative to outside and the tapes B2 and B3 ensure tightness between the cells C1 and C2 and C2 and C3 respectively.

Each cell C1, C2, C3 (represented in dotted lines) is then received in its own compartment 10.1, 10.2, 10.3 respectively. The implementation of a single shell E (represented in dotted lines in FIG. 3) to make all the compartments has the advantage to enable the tight separation of the cells to be readily made and enables the connection zones of carbon fibres to be protected between cells. As a variant, it could be contemplated to use a unit shell to confine one cell at a time and also to cover all the connection zones of the collectors extending between the cells.

During a following step, the compartments are sealed by applying heating to the shell on the contours of each cell, for example a localised heating is applied at a temperature in the order of 180° C. under vacuum. An aperture is provided in each compartment to enable then each compartment to be filled with an electrolyte and the compartments are sealed. For example, the shell can be heat sealed on three sides and the fourth side is used for filling the cells with the electrolyte. The fourth side is then heat sealed. The electrolyte is for example a mixture of EP/PC/DMC(1/1/3)1 MLiPF₆)+2%-mass VC. This is LP10. LP10 is a mixture of organic solvents in which LiPF₆ (lithium hexafluorophosphate) is dissolved at the 1 mol·l⁻¹ concentration. The solvents making up the mixture are: ethylene carbonate (EC), propylene carbonate (PC) and finally dimethyl carbonate (DMC) in the proportions 1/1/3 volume in which the additive vinylene carbonate (VC) is added at the percentage 2%-mass.

The electrolytic media of the three cells are tightly separated and the electrical continuity between the cells is ensured by the collectors of carbon fibres.

The invention enables tightness problems of the battery to be reduced, indeed the heat sealing operations of the flat elements is easier than the sealing in the case of three-dimension structures.

In the example represented with three cells, wherein the material of the positive electrodes is LiFePO₄ and the negative electrodes are of carbon fibres, the battery has a specific capacity of 28.8 mAh and can reach a nominal voltage of 9.6V and a maximum voltage of 11.1V, each cell having a voltage of 3.2V.

Very simply, the number of cells and thus the nominal voltage of the battery can be increased, without increasing the number of electric connections between the cells to be made because they are directly made by the connectors of carbon fibres.

Further, since the collectors of carbon fibres have some flexibility, in particular the collectors of woven carbon fibres, it is easy to make flexible batteries which can supply objects such as flexible screens and/or batteries of any shape. The batteries can be planar or extend in the three directions of space. It can be considered to wind the cells or to fold them so as to form a stack.

1: A bipolar lithium-ion battery comprising n electrochemical cells connected in series, n being an integer higher than or equal to 2, each electrochemical cell comprising:
a positive electrode,
a current collector carrying the positive electrode,
a negative electrode,
a current collector carrying the negative electrode,
an electrolyte disposed between each pair of positive and negative electrodes,
n−1 current collectors, called common current collectors, each one made as a single piece with the current collector of an adjacent cell, the common current collectors carrying an electrode of each polarity, the n−1 comprising a material comprising carbon fibres,
a shell receiving all the electrochemical cells and defining for each of them a compartment being tight with respect to the compartments of the other electrochemical cells, said compartments being flexible.

2: The bipolar battery according to claim 1, wherein all the current collectors comprise carbon fibres.

3: The bipolar battery according to claim 1, wherein the n−1 common collectors comprise a negative electrode zone with a surface area at least equal to the surface area of the negative electrode, a positive electrode zone with a surface area at least equal to the surface area of the positive electrode and a connection zone with a reduced surface area between the negative electrode zone and the positive electrode zone.

4: The bipolar battery according to claim 1, wherein the positive electrodes comprise LiFePO₄, LiNi_{0.33}Mn_{0.33}Co_{0.33}O₂, LiNiₓCo_{y}Al_{z}O₂ with x+y+z=1, LiMnO₂, LiNiO₂ or of LiNi_{0.4-0.5}Mn_{1.5-1.6}O₄.

5: The bipolar battery according to claim 1, wherein the negative electrodes comprise titanate (Li₄Ti₅O₁₂), silicon, silicon carbide.

6: The bipolar battery according to claim 1, wherein the negative electrodes are directly formed by current collector zones facing a positive electrode.

7: A method for manufacturing a bipolar battery according to claim 1, comprising:
a) providing two unit collectors of electrically conductive material and n−1 common current collectors of carbon fibres,
b) making a negative electrode on a unit current collector,
c) making a positive electrode on another unit current collector,
d) making a negative electrode on a zone of the n−1 common current collectors and a positive electrode on another zone of the n−1 common current collectors,
e) facing n−2 positive electrodes carried by n−2 common current collectors with a negative electrode of the n−2 common collectors and facing a remaining positive electrode carried by a common current collector with the negative electrode of a unit current collector and a remaining negative electrode of a common current collector with the positive electrode of the other unit current collector,
f) placing an electrolyte between each facing pair of positive and negative electrodes,
g) placing the electrochemical cells in at least one shell and tightly separating the electrochemical cells and sealing said at least one shell so as to make a tight compartment for each electrochemical cell.

8: The manufacturing method according to claim 7, wherein step f) is made after placing the electrochemical cells in the shell and before sealing the shell.

9: The manufacturing method according to claim 7, wherein the shell is heat-sealable and heat-sealable tapes are disposed on the common current collectors in the zone between the positive and negative electrodes and a heat application on the heat-sealable tapes occurs.

10: The manufacturing method according to claim 7, wherein the positive electrodes and/or the negative electrodes are made by printing.

11: The manufacturing method according to claim 10, wherein during printing, a suction occurs.

12: The manufacturing method according to claim 7, wherein the positive electrodes and/or the negative electrodes are made by screen printing.

13: The manufacturing method according to claim 12, wherein during screen printing, a suction occurs.
